(19) United States
(12) Patent Application Publication
(10) Pub. No.: US 2025/0374862 A1
(43) Pub. Date: Dec. 11, 2025

(54) CHAFF CUTTING MACHINE FOR COFFEE

(71) Applicant: Jong-hyun Park, Seoul (KR)

(72) Inventor: Jong-hyun Park, Seoul (KR)

(21) Appl. No.: 19/230,077

(22) Filed: Jun. 5, 2025

(30) Foreign Application Priority Data
Jun. 5, 2024 (KR) 10-2024-0073882

(51) Int. Cl. A01F 12/18; A01F 12/10; A01F 12/44

(52) U.S. Cl. CPC A01F 12/18; A01F 12/10; A01F 12/44

(57) ABSTRACT

The present invention relates to a chaff cutting device for coffee with an improved structure that separates coffee beans and chaff from roasted coffee beans by cutting and separating them through a cutter, and easily separates coffee beans and chaff through a cyclone separator having vacuum pressure.

The present invention relates to a chaff cutting device for coffee with an improved structure that can improve the separation efficiency of coffee beans and chaff by separating light chaff from coffee beans using first, second, and third separation plates with different lengths placed in a separator and the inflow of external air.

### CROSS REFERENCE TO RELATED APPLICATIONS

The present disclosure claims the priority of Korean Patent Application No. 10-2024-0073882 filed on Jun. 5, 2024. All the above are hereby incorporated by reference in their entirety.

### TECHNICAL FIELD

The present invention relates to a chaff cutting machine for coffee, and more specifically, to a chaff cutting machine for coffee with improved structure to ensure roasted coffee beans can be cut and separated into coffee beans and chaffs through a cutting machine and coffee beans and chaffs can be easily separated through a cyclone separator with vacuum pressure.

The present invention relates to a chaff cutting machine for coffee with the improved structure to ensure the separation efficiency of coffee beans and chaff can be improved since the light chaff can be separated from coffee beans by using the first, second, and third separating plates placed in the separator with different lengths, and the inflow of external air.

### BACKGROUND ART OF THE INVENTION

Generally, coffee beans are composed of shell, fibrous cell membrane formed in a honeycomb structure inside the shell, and coffee particles inside the cell membrane above. The shell not only has no nutritional value, but also absorbs coffee fat (oil) to reduce the unique flavor of coffee beans, and unnecessary compounds are created by fusing or combining with the cell membrane and coffee particles due to the heat generated during grinding, which not only reduces unique flavor of coffee beans due to the coffee fat further by the compounds, but also causes impure taste in the coffee.

In addition, coffee beans have problems that the cell membranes composed of fiber are forcibly destroyed during the process of finely grinding coffee beans, the impure taste contained in the fiber are revealed due to the heat generated during grinding and additionally a bitter taste is caused by carbonization since the coffee particles are not protected by the cells and the coffee fats burn due to heat.

Accordingly, as a prior art for solving the above problems, the “Coffee Bean Grinder Device” (registration date: 2020 Jan. 14) was published in Korean Patent Gazette No. 10-2068124.

Conventional coffee bean grinder devices have the advantage of easily obtaining coffee bean powder at a desired particle size by grinding inserted coffee beans using a grinding blade.

However, as described above, conventional coffee bean grinder devices have a problem in that the heat generated when coffee beans are finely ground, causes the inner shell to fuse or combine with the cell membrane and coffee particles, making it difficult to smoothly separate coffee beans and the inner shell, and many inner shells and center cuts are still included in the ground coffee beans, which reduces the unique flavor of the coffee due to the impure taste and burnt taste of coffee.

Furthermore, in the conventional coffee bean grinder devices, the center cut and the shell of the coffee bean are not separated but ground during the process of grinding coffee beans. So when the coffee is extracted, the ground center cut and the shell are mixed, making it difficult to extract a good and rich coffee due to impure taste.

Another conventional prior art related to the processing of the existing coffee bean shell, as published in Korean Patent Gazette No. 10-2555200, “Coffee Beans Cutting Device with Easy Center Cut Separation” (Registration date: Jul. 10, 2023) relates to a coffee bean cutting machine which easily separates the center cut to made with vertical grooves in the center of the coffee bean, by the principle of cutting the coffee bean through a cutting section in the process of separating the center cut and the husk from the coffee bean, and then minimizes the occurrence of fine powder.

Existing raw coffee beans go through a processing process to remove the shell and pulp, leaving only a thin film. After roasting and drying, the film that comes off is called chaff, which is required to separate from the beans to enjoy a rich coffee flavor without acidity.

However, since the light chaff is separated from coffee beans and blown inside the separator, it not only has a difficulty in separating the chaff and coffee beans, but also a difficulty in cleaning the inside of the cutter.

In addition, it has a disadvantage that the aroma and taste of the rich coffee beans change due to the acidity if the separation of the chaff and coffee beans through the existing coffee bean processing process is not easy.

Therefore, in the present invention described below, it is available cut and separate the chaff and coffee beans and there is a need to develop a coffee chaff cutting device that can easily improve the efficiency of separating the cut chaff and coffee beans.

### PRIOR ART LITERATURE

### Patent Literature

(Patent literature 0001) Korean Patent Gazette No. 10-2068124 “Coffee Bean Grinder Device” (Registration date: 2020 Jan. 14)

(Patent literature 0002) Korean Patent Gazette No. 10-2555200 “Coffee Beans Cutting Device with Easy Center Cut Separation” (Registration date: Jul. 10, 2023)

### DESCRIPTIONS ON THE INVENTION

### Tasks to be Solved

The present invention was created to solve the above problems after consideration and its purpose is to provide a coffee chaff cutting device with an improved structure to ensure coffee beans and chaff can be cut and separated from roasted coffee beans through a cutting machine and coffee beans and chaff can be easily separated through a cyclone separator with vacuum pressure.

Another purpose of the present invention is to provide a coffee chaff cutting device with an improved structure to ensure the separation efficiency of coffee beans and chaff can be improved since the light chaff can be separated from coffee beans by using the first, second, and third separating plates placed in the separator with different lengths, and the inflow of external air.

### Means for Solving the Tasks

In order to achieve the above purpose, the present invention is characterized by being equipped with a supply means having a feed hopper in which roasted coffee beans are stored, and a transfer conveyor for transferring coffee beans supplied through the feed hopper to an input hopper; a cutting machine with a input hopper equipped with a transfer roller that receives coffee beans supplied through the supply means and transfers the coffee beans downward, first and second cutting rollers that are placed below the input hopper and crush coffee beans that fall from the input hopper and separate chaff from the coffee beans, and a supply box equipped with a vacuum suction line that collects the cut coffee beans and chaff while passing between the first and second cutting rollers and suctions and transfers the coffee beans and chaff to a separation casing by vacuum pressure; a separator equipped with a separation casing above with an outlet prepared on the lower side and connected to a first dust collection hose that separates coffee beans and chaff supplied from the cutter by centrifugal separation using a cyclone and sucks the chaff with the suction force of a vacuum pump and transfers it to the dust collector, a separation casing above that is placed on the lower side of the separation casing and separates coffee beans and chaff that fall from the discharge port of the separation casing and the second dust collection hose above that is connected to the separation casing and sucks the chaff in the separation casing with the suction force of a vacuum pump and transfers it to the dust collector and a collection box above which is placed on the lower side of the separation chute and collects coffee beans separated from the above chaff; and a dust collector which is equipped with a vacuum pump to suck the chaff through the first and second dust collecting hoses above, and collects the chaff sucked through the first and second dust collecting hoses above.

The first and second cutting rollers above are each composed of a cushion material made of an elastic material on the outer surface of each rotation axis, and a cutting protrusion protruding toward the outer surface of the cushion material above.

The separation chute above is equipped with an outside air inlet connected to allow outside air to flow in, a damper placed on the outside of the separation chute above to control the opening and closing operation of the outside air inlet above, and first, second, and third separation plates with different lengths placed on the inside of the separation chute.

The first, second, and third separating plates above have different lengths to ensure each end has a length difference, and are placed to ensure they have different inclination angles.

A cleaning means should be more equipped with to remove chaff that is attached to the outer peripheral surface of the first and second cutting rollers above and is placed above the first and second cutting rollers, and the cleaning means above is equipped with a fluid supply pipe with a plurality of spray nozzles that are placed above the first and second cutting rollers and sprays fluid supplied from the outside toward the first and second cutting rollers located below.

### Effect of the Invention

The present invention has advantages that coffee beans and chaff for easy peeling out and the peeled-out coffee beans and chaff can be easily separated by passing through a cyclone-type separation casing, and at the same time, the chaff can be easily collected toward the dust collector by the vacuum suction force introduced through the first dust collecting hose.

In addition, the present invention has the advantage of easily separating coffee beans and chaff by using the weight difference between coffee beans and chaff within the separation chute, and at the same time, the outside air introduced into the separation chute through the outside air inlet and easily collecting chaff toward the dust collector by the vacuum suction force introduced through the second dust collecting hose

In addition, the present invention has the advantage of easily collecting light chaff by using the vacuum suction force of the vacuum pump equipped within the dust collector and easily separating it from coffee beans.

### BRIEF DESCRIPTION OF THE DRAWINGS

FIG. 1 is a configuration diagram showing the configuration of a coffee chaff cutting device according to the present invention.

FIG. 2 is a plan view of FIG. 1.

FIG. 3 is a configuration diagram showing the configuration of a cutting machine of the present invention.

FIG. 4 is a diagram schematically showing the configuration of the first and second cutting rollers of the present invention.

FIG. 5 is a configuration diagram showing the configuration of a separator of the present invention.

### SPECIFIC DETAILS FOR EMBODYING THE INVENTION

In describing the present invention, if it is determined that a specific description of related published art or configurations may unnecessarily obscure the points of the present invention, a detailed description thereof will be omitted. In addition, the terms described below are those defined in consideration of their functions in the present invention and may vary depending on the user's intention or custom. Therefore, the definitions should be made based on the contents throughout this specification. In addition, ‘including’ a certain component does not exclude other components unless otherwise specifically stated, but means that other components may be included without limitation.

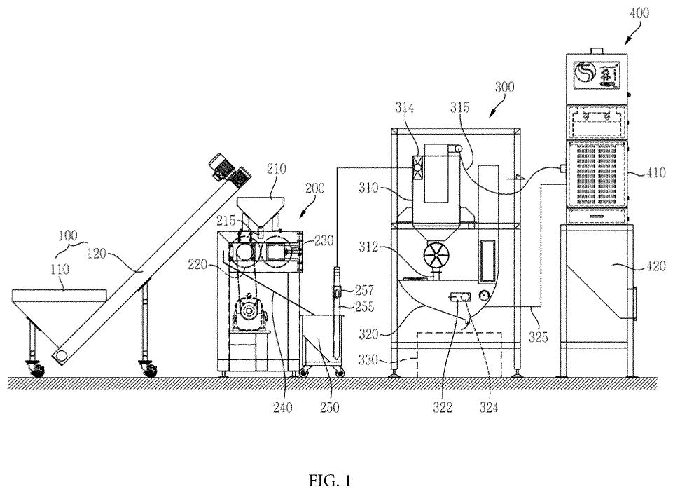

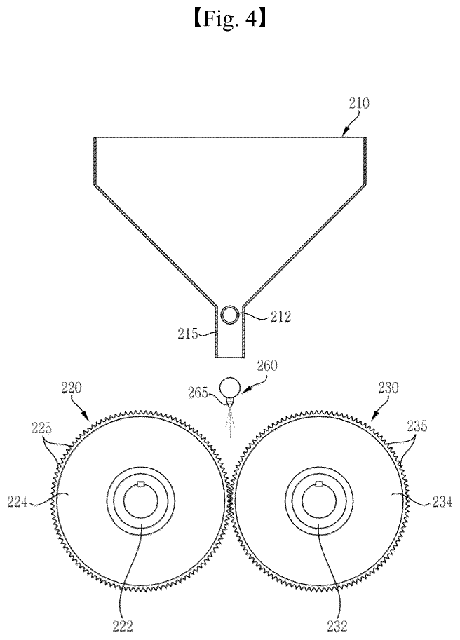

To explain by referring to FIG. 1 through FIG. 5, the coffee bean cutting device consists of a supply means having a feed hopper (110) in which roasted coffee beans are stored, and a transfer conveyor for transferring coffee beans supplied through the feed hopper (100) to an input hopper (210); A cutting machine (200) with a input hopper (210) equipped with a transfer roller (212) that receives coffee beans supplied through the supply means (100) and transfers the coffee beans downward, first and second cutting rollers (220, 230) that are placed below the input hopper (210) and crush coffee beans that fall from the input hopper (210) and separate chaff from the coffee beans, and a supply box (250) equipped with a vacuum suction line (255) that collects the cut coffee beans and chaff while passing between the first and second cutting rollers (220, 230) and suctions and transfers the coffee beans and chaff to a separation casing (310) by vacuum pressure; a separator (300) equipped with a separation casing above (310) with an outlet (312) prepared on the lower side and connected to a first dust collection hose (315) that separates coffee beans and chaff supplied from the cutter (200) by centrifugal separation using a cyclone (314) and sucks the chaff with the suction force of a vacuum pump (410) and transfers it to the dust collector (400), a separation casing above (310) that is placed on the lower side of the separation casing (310) and separates coffee beans and chaff that fall from the discharge port (312) of the separation casing (310) and the second dust collection hose above (325) that is connected to the separation casing (320) and sucks the chaff in the separation casing (320) with the suction force of a vacuum pump (410) and transfers it to the dust collector (400) and a collection box above (330) which is placed on the lower side of the separation chute (320) and collects coffee beans separated from the above chaff; and a dust collector (400) which is equipped with a vacuum pump to suck the chaff through the first and second dust collecting hoses (315, 325) above, and collects the chaff sucked through the first and second dust collecting hoses above (315, 325).

The coffee chaff cutting device of the present invention consists of a cutter (200) that cuts chaff from coffee beans, a separator (300) that separates coffee beans and chaff, and a dust collector (400) that sucks the separated chaff with vacuum pressure and collects dust.

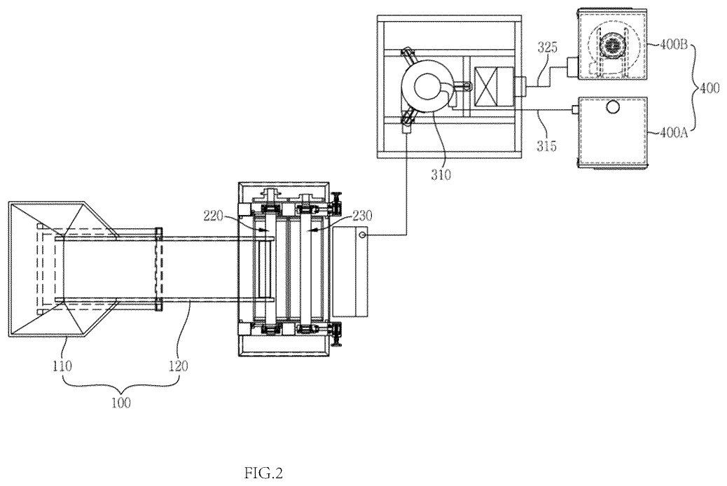

Referring to FIG. 1 and FIG. 2, the cutter above (200) is equipped with an input hopper (210) that is opened at the top to receive roasted coffee beans to be supplied and dropped through the transfer conveyor (120) of the supply means (100) at the top.

In addition, the input hopper above (210) is equipped with a transfer roller (212) inside, and the transfer roller above (212) performs the function of controlling the discharge volume of coffee beans discharged through the open lower inlet (215).

Inside the cutting machine above (200), the first and second cutting rollers (220, 230) are placed available to rotate, and perform the function of removing the film (chaff) covering the surface of coffee beans while coffee beans pass between the first and second cutting rollers (220, 230).

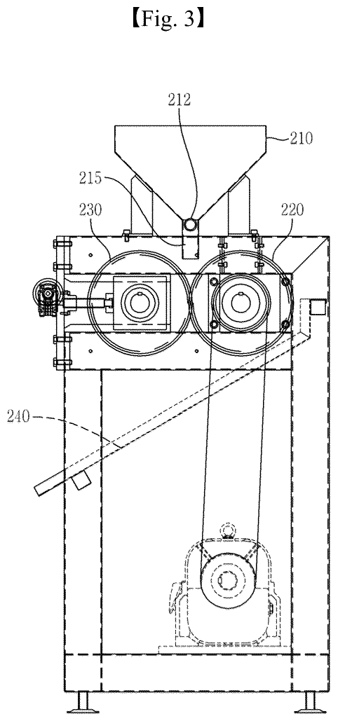

The first and second cutting rollers above (220, 230) for this consist of cushioning materials (224, 234) made of elastic materials on the outer peripheral surface of each rotation shaft (222, 232), as shown in FIG. 3, and cutting protrusion (225, 235) protruding toward the outer surface of the cushioning materials (224, 234).

In addition, it is more preferable that the cutting protrusion above (225, 235) protrudes in a spiral shape on the outer surface of the cushion material (224, 234) for the separation of coffee beans and chaff.

The cutting machine above (200) is further equipped with a cleaning means for removing the chaff that sticks to the outer surface of the first and second cutting rollers (220, 230) and is placed above the first and second cutting rollers (220, 230).

The cleaning means above is equipped with a fluid supply pipe (260) with a plurality of spray nozzles (265) for spraying a fluid supplied from the outside toward the first and second cutting rollers (220, 230) located below.

The above injection nozzle above (265) performs the function of, for example, spraying compressed air, water or steam toward the first and second cutting rollers (220, 230) to separate the chaff attached to the surface of the first and second cutting rollers (220, 230).

In addition, the cutting machine above (200) is further equipped with an inclined conveying plate (240) that guides coffee beans and chaff to fall toward the supply box (250) of the lower side of the first and second cutting rollers (220, 230).

As shown in FIG. 1, the supply box (250) has an open top to collect coffee beans and chaff falling along the transfer plate (240), and a vacuum suction line (255) is provided to suction and transfer coffee beans and chaff inside the supply box (250) toward the separation casing (310) using vacuum pressure.

The vacuum suction line above (255) is more equipped with a rotary valve (257) to ensure vacuum pressure can be selectively applied to the inside of the supply box (250).

The separator above (300) is equipped with a separation casing (310) in which a centrifugal cyclone method is adopted inside the separation chamber (305), and a separation chute (320) is provided to ensure the separated coffee beans and chaff may be separated while falling to the lower part of the separation casing (310).

The separation casing above (310) performs the function of centrifugally separating coffee beans and chaff using a cyclone (314), and discharges the centrifugally separated coffee beans and chaff through the outlet (312) located at the bottom.

In addition, since the separation casing above (310) is connected to the dust collector (400) side through the first dust collecting hose (315), the chaff on the separation casing (310) is sucked toward the dust collector (400) side through the first dust collecting hose (315) as the vacuum pressure is transmitted to the separation casing (310) by the vacuum pump (410) in the dust collector (400).

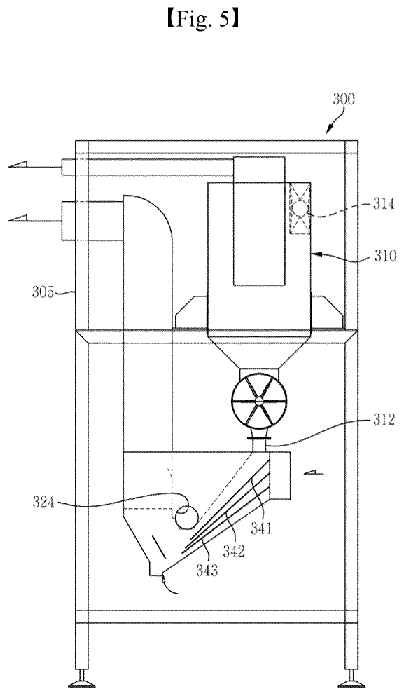

As shown in FIG. 5, the separation chute above (320) is equipped with an outside air inlet (324) connected to allow outside air to flow in, a damper (322) placed on the outside of the separation chute (320) to control the opening and closing operation of the outside air inlet (324), and first, second, and third separation plates (341, 342, 343) placed on the inside of the separation chute (320) with different lengths.

The first, second, and third separation plates above (341, 342, 343) are placed to ensure each end is placed in a stepped form, and have different inclination angles.

The first, second, and third separation plates above (341, 342, 343) perform the function of guiding coffee beans and chaff to be separated from each other due to the weight difference while they fall to the lower side of the separation casing (310).

That is, coffee beans which are heavier than the chaff are not affected by the outside air flowing into inside of the separation chute (320) and fall toward the collection box (330) prepared at the lower side of the separation chute (320) through the outlet located at the lower side of the separation chute (320), and the chaff inside the separation chute (320) is sucked toward the dust collector (400) through the second dust collection hose (325) connected to the dust collector (400).

The dust collector above (400) is equipped with a vacuum pump (410) inside, and a discharge chute (420) for discharging the chaff to the outside is equipped on the lower side of the vacuum pump (410).

More preferably, the dust collector above (400) may consist of the first dust collector (400A) connected to the separation casing (310) via the first dust collector hose (315), and the second dust collector (400B) connected to the separation chute (320) via the second dust collector hose (325), as shown in FIG. 2.

As shown in FIG. 1 and FIG. 2, the present invention with such a configuration supplies roasted coffee beans in a way where roasted coffee beans are supplied to the feed hopper (110) of the supply means (100), coffee beans in the feed hopper (110) are transported to the upper side of the input hopper (210) via the transfer conveyor (120) and then dropped into the input hopper (210).

Then, coffee beans supplied into the input hopper (210) located on the upper side of the separator (300) are fed into the first and second cutting rollers (220, 230) inside the separator (300) in a certain amount according to the rotation of the transfer roller (212), and coffee beans and chaff are separated from each other while passing through the contacting portions of the first and second cutting rollers (220, 230) and then captured inside the supply box (250) falling down along the transfer plate (240).

The separation casing above (310) is a separation device using the centrifugal force. As coffee beans and chaff collected in the supply box (250) are fed into the interior of the separation casing (310) through the vacuum suction line (255), coffee beans and chaff are separated by centrifugal separation, and the separated chaff is vacuum-sucked toward the dust collector (400) through the first dust collection hose (315), and the remaining chaff and coffee beans fall toward the lower separation chute (320) through the outlet (312).

Coffee beans and chaff that fall toward the above separation chute (320) can be easily separated due to the weight difference by using the first, second, and third separation plates (341, 342, 343) placed at an inclined angle and the outside air that flows in through the outside air inlet (324) while coffee beans and chaff fall through the lower exit of the separation chute (320). The chaff separated in the separation chute (320) is sucked toward the dust collector (400) side by the vacuum suction force through the second dust collection hose (325).

The dust collector above (400) can capture the chaff inside the separation casing (310) and the chaff inside the separation chute (320) through the first and second dust collector hoses (315, 325) by the vacuum suction force of the vacuum pump (410), and the collected chaff can be discharged to the outside through the discharge chute (420) at the bottom.

Therefore, the present invention can cut coffee beans and chaff to ensure they can be easily peeled off, and the peeled coffee beans and chaff can be easily separated while passing through the separation casing (310) to which the cyclone (314) is applied, and at the same time, it has the useful advantage of being able to easily collect the chaff toward the dust collector (400) side by the vacuum suction force introduced through the first dust collector hose (315).

In addition, the present invention can easily separate coffee beans and chaff by using the weight difference between coffee beans and chaff in the separation chute (320) and by using the outside air that is introduced into the separation chute (320) through the outside air inlet (324), and can easily collect chaff toward the dust collector (400) side by the vacuum suction force introduced through the second dust collection hose (325).

Besides, the present invention has the advantage of easily collecting light chaff and easily separating it from coffee beans using the vacuum suction force of the vacuum pump (410) equipped within the dust collector (400).

As above, in the detailed description of the present invention, examples of specific embodiments have been described. Therefore, the scope of the present invention should not be limited to the examples of embodiments described above, but should be determined by not only the claims described below but also the equivalents of the claims.

That is, the present invention described above is not limited to the specific desirable embodiments described above, and anyone with ordinary knowledge in the technical field to which the present invention belongs can make various modifications not beyond the points of the present invention claimed in the claims, and such modifications are within the scope of the claims.

### DESCRIPTIONS ON SYMBOLS

100: Supply means
110: Feed hopper
120: Transfer conveyor
200: Cutter
210: Input hopper
212: Transfer roller
215: Inlet
220,230: 1st and 2nd cutting roller
222,232: Rotating shaft
224,234: Cushion materials
225,235: Cutting protrusion
240: Transfer plate
250: Supply box
255: Vacuum suction line
257: Rotary valve
300: Separator
305: Separation chamber
310: Separation casing
312: Outlet
314: Cyclone
315: 1st dust collection hose
320: Separation chute
322: Damper
324: Outside air inlet
325: 2nd dust collector hose
330: Collection box
341,342,343: 1st, 2nd and 3rd separation plate
400: Dust collector
400A,400B: 1st and 2nd dust collector
410: Vacuum pump
420: Discharge chute

1. A chaff cutting device characterized by being equipped with a supply means having a feed hopper (110) in which roasted coffee beans are stored, and a transfer conveyor for transferring coffee beans supplied through the feed hopper (100) to an input hopper (210);
a cutting machine (200) with a input hopper (210) equipped with a transfer roller (212) that receives coffee beans supplied through the supply means (100) and transfers the coffee beans downward, first and second cutting rollers (220, 230) that are placed below the input hopper (210) and crush coffee beans that fall from the input hopper (210) and separate chaff from the coffee beans, and a supply box (250) equipped with a vacuum suction line (255) that collects the cut coffee beans and chaff while passing between the first and second cutting rollers (220, 230) and suctions and transfers the coffee beans and chaff to a separation casing (310) by vacuum pressure;
a separator (300) equipped with a separation casing above (310) with an outlet (312) prepared on the lower side and connected to a first dust collection hose (315) that separates coffee beans and chaff supplied from the cutter (200) by centrifugal separation using a cyclone (314) and sucks the chaff with the suction force of a vacuum pump (410) and transfers it to the dust collector (400), a separation casing above (310) that is placed on the lower side of the separation casing (310) and separates coffee beans and chaff that fall from the discharge port (312) of the separation casing (310) and the second dust collection hose above (325) that is connected to the separation casing (320) and sucks the chaff in the separation casing (320) with the suction force of a vacuum pump (410) and transfers it to the dust collector (400) and a collection box above (330) which is placed on the lower side of the separation chute (320) and collects coffee beans separated from the above chaff; and
a dust collector (400) which is equipped with a vacuum pump to suck the chaff through the first and second dust collecting hoses (315, 325) above, and collects the chaff sucked through the first and second dust collecting hoses above (315, 325).

2. The chaff cutting device according to claim 1, characterized by consisting of the first and second cutting rollers (220, 230) with cushioning material (224, 234) made of an elastic material on the outer surface of each rotation shaft (222, 232), and a cutting projection (225, 235) protruding toward the outer surface of the cushioning material (224, 234).

3. The chaff cutting device according to claim 1, characterized by being equipped with the separation chute (320) which is provided with an outside air inlet (324) connected to allow outside air to be introduced,
a damper (322) placed on the outside of the separation chute (320) to control the opening and closing operation of the outside air inlet (324),
and first, second, and third separation plates (341, 342, 343) placed on the inside of the separation chute (320) with different lengths.

4. The chaff cutting device according to claim 1, characterized by placement of the first, second, and third separation plates (341, 342, 343) with different lengths so as to have a difference in length of each end and are placed to have different inclination angles.

5. The chaff cutting device according to claim 1, characterized by being more equipped with a cleaning means which is placed to the upper side of the first and second cutting rollers (220, 230) and used for removing chaff adheres to the outer peripheral surface of the first and second cutting rollers (220, 230) but the cleaning means above has a fluid supply pipe (260) which is placed at the upper side between the first and second cutting rollers above (220, 230) and equipped with a plurality of spray nozzles (265) for spraying fluid supplied from the outside toward the first and second cutting roller sides (220, 230) located below.
